(19) United States
(12) Patent Application Publication
(10) Pub. No.: US 2012/0296009 A1
(43) Pub. Date: Nov. 22, 2012

(54) SYNTACTIC FOAM

(75) Inventors: Matthew Cleaver, Haverhill (GB); Rhian Lewis, St. Neots (GB)

(73) Assignee: HEXCEL COMPOSITES LIMITED, Duxford (GB)

(21) Appl. No.: 13/505,526

(22) PCT Filed: Nov. 3, 2010
(86) PCT No.: PCT/GB2010/051839

§ 371 Date: Aug. 9, 2012

(30) Foreign Application Priority Data
Nov. 4, 2009 (GB) 0919322.8

(51) Int. Cl. C08K 7/22; C08L 63/02

(52) U.S. Cl. 523/218

(57) ABSTRACT

A one-component syntactic paste comprising epoxy resin, hollow particles and a hydrazide curing agent.

### TECHNICAL FIELD

The invention relates to a one-component syntactic foam curable at an elevated temperature with a low tendency to exotherm.

### BACKGROUND

Materials known as syntactic foams find use in a number of technical areas, such as low density fillers and for repairing damage to composite material structures.

Syntactic foams derive their low densities from the hollow particles they contain which are dispersed within a structural matrix, typically of resin such as epoxy resin.

Syntactic foams are formed by curing a paste or putty-like material which comprises the uncured resin, curing agent, and hollow particles. Such curable materials are sometimes referred to as syntactic pastes.

To prevent the syntactic paste from prematurely curing before it is desired, the curing agent and resin can be physically separated and mixed together immediately prior to application of the paste. Such a product is known as a two-component syntactic paste.

However, mixing the two components together before use is cumbersome and time consuming. Therefore so-called one-component systems are greatly preferred. Such one-component systems involve the resin and curing agent to be together in the same paste and are prevented from reacting due to selection of a curing agent which is reactive only at an elevated temperature. One-component pastes may be stored at low temperatures and applied as desired. Once in place the paste is exposed to an elevated temperature and it cures to produce a syntactic foam.

However, a well-known hazard of such one-component systems is their tendency to exotherm. The presence of the hollow particles, often in very high quantities, tends to produce a material with a low thermal conductivity. As heat is generated during curing, this being an exothermic process, the internal temperature of the paste can rise uncontrollably and cause combustion of the material, a process called exotherming.

US 2007/0037575 discloses a room-temperature curing syntactic paste which is claimed to have a low tendency to exotherm and can be used to repair structures over large areas.

However, curing at low temperatures may result in inadequate mechanical properties of the cured syntactic foam e.g. due to incomplete curing. Addressing this by curing at elevated temperatures, e.g. above 80° C. or even above 120° C. and even as high as 175° C., appears to inevitably result in exotherming to the point of combustion with known syntactic pastes.

Thus a low density one-component syntactic paste with acceptable mechanical properties upon curing and a low tendency to exotherm would be highly desirable.

### SUMMARY OF THE INVENTION

In a first aspect, the invention relates to a one-component syntactic paste comprising epoxy resin, hollow particles and a hydrazide curing agent.

Such syntactic pastes are curable at an elevated temperature of at least 80° C. without exotherming with a reasonable volume of material and also cure to produce a foam with excellent mechanical properties.

Additionally, such pastes can advantageously be cured over a range of temperatures, e.g. from 80° C. to 190° C. and provide good mechanical properties without significantly exotherming upon cure. Preferably they cure in the range of temperatures from 120° C. to 175° C. without exotherming.

The hollow particles may be rigid or flexible. They also typically have a small particle size with a mean particle size of from 10 to 200 micrometres.

As they are hollow, they have a low density, with a typical density being from 0.20 to 0.50 g/cm³.

In order for the syntactic paste to have a low material density it is preferred that a large proportion of it is made up of the hollow particles. Thus, the syntactic paste preferably comprises from 10 to 40 wt % of the hollow particles. On a volume basis the figures are much higher, with the syntactic paste preferably comprising from 40 to 90% by volume the hollow particles.

By employing a sufficient quantity of hollow particles a light syntactic paste is obtainable. Thus, the syntactic paste preferably has a density of less than 0.80 g/cm³.

The epoxy resin may comprise monofunctional, difunctional, trifunctional and/or tetrafunctional epoxy resins.

Suitable difunctional epoxy resins, by way of example, include those based on; diglycidyl ether of Bisphenol F, Bisphenol A (optionally brominated), phenol and cresol epoxy novolacs, glycidyl ethers of phenol-aldelyde adducts, glycidyl ethers of aliphatic diols, diglycidyl ether, diethylene glycol diglycidyl ether, aromatic epoxy resins, aliphatic polyglycidyl ethers, epoxidised olefins, brominated resins, aromatic glycidyl amines, heterocyclic glycidyl imidines and amides, glycidyl ethers, fluorinated epoxy resins, or any combination thereof.

Difunctional epoxy resins may be preferably selected from diglycidyl ether of Bisphenol F, diglycidyl ether of Bisphenol A, diglycidyl dihydroxy naphthalene, or any combination thereof.

Suitable trifunctional epoxy resins, by way of example, may include those based upon phenol and cresol epoxy novolacs, glycidyl ethers of phenol-aldehyde adducts, aromatic epoxy resins, aliphatic triglycidyl ethers, dialiphatic triglycidyl ethers, aliphatic polyglycidyl ethers, epoxidised olefins, brominated resins, triglycidyl aminophenyls, aromatic glycidyl amines, heterocyclic glycidyl imidines and amides, glycidyl ethers, fluorinated epoxy resins, or any combination thereof.

Suitable tetrafunctional epoxy resins include N,N,N′,N′-tetraglycidyl-m-xylenediamine (available commercially from Mitsubishi Gas Chemical Company under the name Tetrad-X, and as Erisys GA-240 from CVC Chemicals).

The epoxy resin may be present in the syntactic paste at a level of from 30 to 60 wt %.

In order for the hydrazide to be able to cure it must be in liquid form. Thus, the hydrazide preferably has a melting temperature of less than 175° C., more preferably less than 150° C., most preferably less than 125° C.

The hydrazide may comprise a monohydrazide, dihydrazide, trihydrazide or tetrahydrazide. Dihydrazides and trihydrazides are preferred, particularly dihydrazides.

Suitable hydrazides include, but are not limited to, 2,4-dihydroybenzoic acid hydrazide, oxalyl dihydrazide, 4-amino benzoic hydrazide, isophthalic dihydrazide, sebastic acid dihydrazide, adipic acid dihydrazide, icosanedioic acid dihydrazide, succinic dihydrazide, 3-fluorobenzoic hydrazide, valine dihydrazide, toluene sulphonic acid and 2-furoic hydrazide.

Preferably the hydrazide is selected from the list consisting of sebastic acid dihydrazide, adipic acid dihydrazide, icosanedioic acid dihydrazide, succinic dihydrazide, 3-fluorobenzoic hydrazide, valine dihydrazide, toluene sulphonic acid and 2-furoic hydrazide.

More preferably the hydrazide is selected from the list consisting of succinic dihydrazide, 3-fluorobenzoic hydrazide, valine dihydrazide, toluene sulphonic acid and 2-furoic hydrazide. Succinic dihydrazide and valine dihydrazide are most preferred. Most highly preferred is valine dihydrazide.

The hydrazide may be present in the syntactic paste at a level of from 5 to 20 wt %.

Epoxy resin curing systems are often characterised by the amine:epoxy ratio, or A:E ratio. This is the ratio of the number of active hydrogen groups (with hydrazides having two active hydrogens per hydrazide group) to the number of epoxy groups.

For conventional epoxy curing systems, an A:E ratio of 1:1 might provide the most effective curing regime as all the epoxy groups have an active hydrogen group to react with. However, in the present case it has been found that further improvements in mechanical properties can be achieved with an A:E ratio which deviates from 1:1.

Thus, preferably the A:E ratio of from 1:0.4 to 1:0.9, more preferably from 1:0.5 to 1:0.8, most preferably from 1:0.55 to 1:0.75. A particularly preferred ratio is from 1:0.6 to 1:0.7.

It has been found that accelerators may contribute to exotherm behaviour, especially at the higher curing temperature. Thus, preferably the syntactic paste comprises less than 1.0 wt % accelerator, more preferably less than 0.5 wt % and most preferably is substantially free of accelerator.

The syntactic paste also desirably includes a flame retardant material, such as ammonium polyphosphate, red phosphorous or organophosphorous compounds, e.g. an ammonium polyphosphate such as Exolit AP 462 (Trade Mark) obtainable from Clariant. The flame retardant may be present in the syntactic paste at a level of from 5 to 20 wt %.

The syntactic paste also desirably includes particulate filler material. This tends to prevent the hollow particles from phase-separating due to their low density as the paste heats up at the initial stages of curing. Suitable fillers include silica based materials and may be present at a level of from 0.5 to 3.0 wt %.

As mentioned above, the tendency of a material to exotherm may be diminished by ensuring that only small quantities of material are cured. This enables the heat to transfer to the outer surface more quickly, thus preventing build-up of heat internally.

However, most applications require larger amounts of material to be cured together, for example to repair a wider range of sizes of holes in a composite material. Thus, the syntactic paste preferably has a mass of at least 100 g, more preferably at least 300 g.

The syntactic pastes of the present invention have a particularly low tendency to exotherm and a 100 g mass of the paste will exotherm by less than 70° C., preferably less than 50° C., or even less than 30° C. The exotherm is defined as the temperature of the paste minus the temperature of the environment.

Alternatively, the tendency of a material may be diminished if the paste has a high surface-to-volume ratio. Thus an amount of paste with a surface-to-volume ratio of 2.0 cm²/cm³ will exotherm by less than 70° C., preferably less than 50° C., or even less than 30° C.

It is particularly beneficial if the temperature of the paste does not exceed 195° C. even when the environment is as hot as 175° C., and particularly at all environment temperatures in the range of from 120° C. to 175° C.

It is highly desirable to have a paste which cures over a range of temperatures whilst still providing good mechanical properties and not exotherming throughout the range of temperatures.

As mentioned above, the lowest temperature at which a hydrazide can begin to cure effectively is at its melting temperature. The highest temperature at which it can cure is governed by its tendency to exotherm. Thus the greater the difference between these two temperature limits, the wider the range of applications the paste can be applied to. Thus, the paste preferably cures over a temperature range of at least 20° C., preferably at least 30° C., more preferably at least 40° C., or even at least 50° C.

Also as discussed above, it is preferred that it can do this by exotherming by less than 70° C., preferably less than 50° C., more preferably less than 30° C.

The syntactic paste is manufactured typically by simply blending or admixing the constituent materials together. The paste is then stored at a low temperature, typically below 5° C. to prevent any premature curing.

When it is desired to employ the syntactic paste, the paste is applied, e.g. to fill a sandwich panel of an aircraft or to repair a damaged composite material. The structure comprising the paste is then heated up to an elevated temperature to cure the syntactic paste.

Thus, in a further aspect, the invention relates to a process of curing a syntactic paste as defined herein, comprising heating the paste by exposing it to an environment at a temperature of at least 80° C. to produce a cured syntactic foam.

As mentioned, the paste has a low tendency to exotherm and thus the temperature of the paste preferably does not exceed 70° C. greater than the environment temperature, more preferably does not exceed 50° C. greater and most preferably does not exceed 30° C. greater.

Preferably the environment temperature is at least 100° C., more preferably at least 125° C., most preferably at least 150° C.

The cured syntactic foam desirably has a high compressive strength. Preferably it has a compressive strength at room temperature of at least 16 Nmm⁻², more preferably at least 25 Nmm⁻².

The syntactic paste is suitable for use in a variety of applications. However it is of particular utility where a low density adhesive material is desired. Thus in a preferred embodiment, the process includes the step of applying the paste to an aircraft sandwich panel before curing.

The invention will now be illustrated with reference to the following figures, in which:

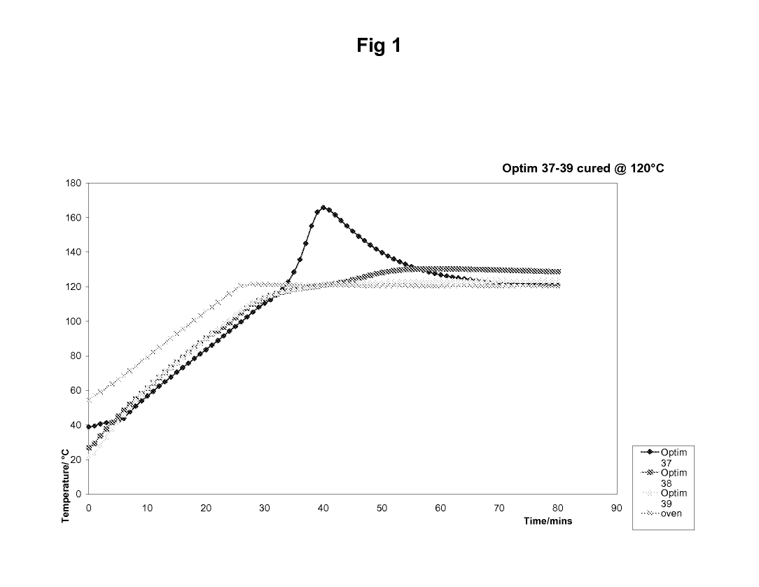

FIG. 1 is a chart of temperature against time where Examples 37 to 39 are cured at 120° C.

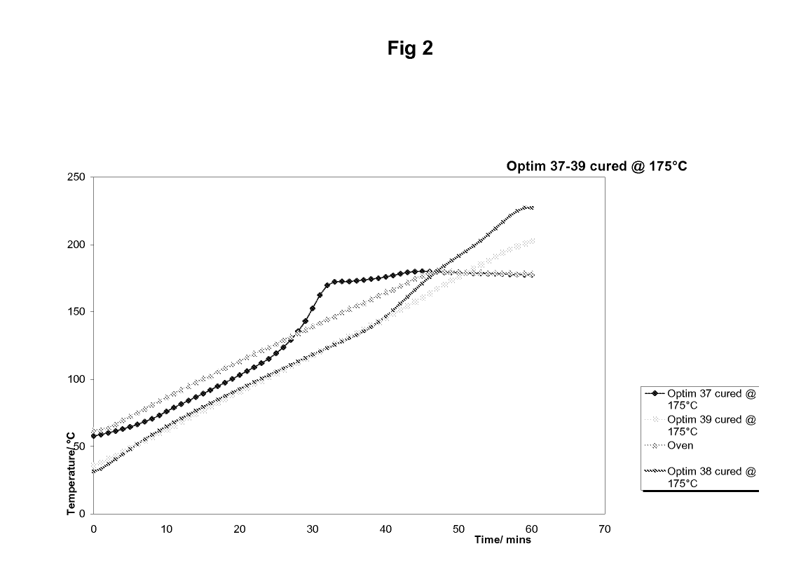

FIG. 2 is a chart of temperature against time where Examples 37 to 39 are cured at 175° C.

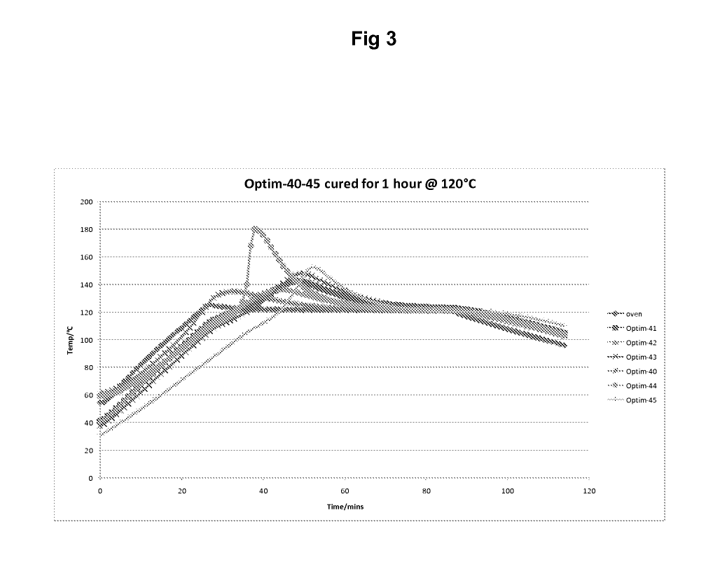

FIG. 3 is a chart of temperature against time where Examples 40 to 45 are cured at 120° C.

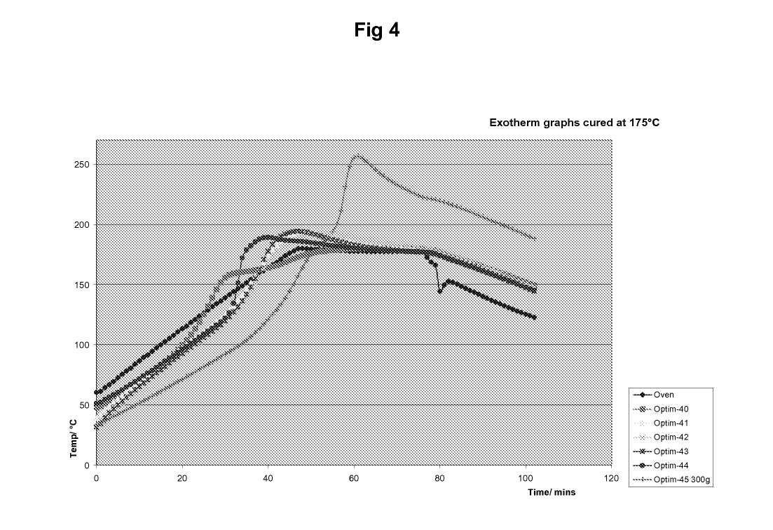

FIG. 4 is a chart of temperature against time where Examples 40 to 45 are cured at 175° C.

### EXAMPLES

A series of syntactic pastes were manufactured and a mass of 100 g of each paste was cured at 120° C. and also at 175° C. The pastes were formed into cylinder shapes with diameters fixed at 11.0 cm, providing a surface-to-volume ratio of 1.70 cm²/cm³. The formulations and the results are shown below.

Examples marked with a * are examples according to the invention.

The behaviour upon curing is measured according to the following scale.

1. Well scorched—obvious exotherm due to odour and colour.
2. Less scorched—slight odour of exotherm.
3. Off-white but well cured—no evidence of exotherm.
4. White—fully cured and solid.
5. Not fully cured—slightly soft.
6. Very undercured—soft.
Δ Indicates bubbling at surface.
+ Indicates segregation during curing.

A score of 3 or 4 at both 120° C. and 175° C. with no bubbling or segregation is a success.

TABLE 1

| Type | Material | 1 | 2 | 3 | 4 | 5 | 6 | 7 | 8 | 9 | 10 | 11 | 12 |
|---|---|---|---|---|---|---|---|---|---|---|---|---|---|
| Epoxy | DLS 772 | 52 | 52.5 | 53 | 53.5 | 54 | 54.5 | 55 | 55.5 | 56 | 56.5 | 56 | 55.5 |
| | Epikote 828 | | | | | | | | | | | | |
| Hollow | Nanolite 37 c2 | 27.5 | 27.5 | 27.5 | 27.5 | 27.5 | 27.5 | 27.5 | 27.5 | 27.5 | 27.5 | 27.5 | 27.5 |
| Particles | | | | | | | | | | | | | |
| Curing | Dicyandiamide | 6 | 5.5 | 5.5 | 5 | 5 | 4.5 | 4.5 | 4 | 4 | 3 | 3 | 3 |
| Agent | MMIPA | | | | | | | | | | | | |
| | MDEA | | | | | | | | | | | | |
| | MCDEA | | | | | | | | | | | | |
| | VDH | | | | | | | | | | | | |
| | TSAH | | | | | | | | | | | | |
| | MZ Azine | | | | | | | | | | | | |
| Accelerator | Dyhard | 2.5 | 2.5 | 2 | 2 | 1.5 | 1.5 | 1 | 1 | 0.5 | 1 | 1.5 | 2 |
| | UR500 | | | | | | | | | | | | |
| Flame | Exolit | 12 | 12 | 12 | 12 | 12 | 12 | 12 | 12 | 12 | 12 | 12 | 12 |
| Retardant | AP462 | | | | | | | | | | | | |
| Silica | Cab-O-Sil | | | | | | | | | | | | |
| particles | TS720 | | | | | | | | | | | | |
| | A:E ratio | | | | | | | 1:0.84 | 1:0.74 | 1:0.73 | 1:0.57 | 1:0.59 | 1:0.61 |

| | | | | | | | | | | | | |
|---|---|---|---|---|---|---|---|---|---|---|---|---|
| Curing at 120 C. | 5 | 5 | 5 | 5 | 5 | 5 | 5 | 5 | 5 | 4 | 4 | 4 |
| Curing at 175 C. | 1 | 1 | 1 | 1 | 1 | 1 | 1 | 1 | 1 | 1 | 1 | 1 |

TABLE 2

| Type | Material | 13 | 14 | 15 | 16 | 17 | 18 | 19 | 20 | 21 | 22 | 23 | 24 |
|---|---|---|---|---|---|---|---|---|---|---|---|---|---|
| Epoxy | DLS 772 | 55.5 | 56.5 | 55.5 | 57 | 56.5 | 57 | 56.5 | 50.8 | 50.8 | 48.5 | 44.2 | 49.36 |
| | Epikote 828 | | | | | | | | | | | | |
| Hollow | Nanolite 37 c2 | 27.5 | 27.5 | 27.5 | 27.5 | 27.5 | 27.5 | 27.5 | 27 | 27 | 27 | 27 | 27 |
| Particles | | | | | | | | | | | | | |
| Curing | Dicyandiamide | 3 | 2 | 0 | 1.5 | 1.5 | 1 | 1 | | | | | |
| Agent | MMIPA | | | | | | | | 10.2 | | | | |
| | MDEA | | | | | | | | | 10.2 | | | 5 |
| | MCDEA | | | | | | | | | | 12 | 16 | 6.14 |
| | VDH | | | | | | | | | | | | |
| | TSAH | | | | | | | | | | | | |
| | MZ Azine | | | | | | | | | | | | |
| Accelerator | Dyhard | 2 | 2 | 5 | 2 | 2.5 | 2.5 | 3 | | | | | |
| | UR500 | | | | | | | | | | | | |
| Flame | Exolit | 12 | 12 | 12 | 12 | 12 | 12 | 12 | 12 | 12 | 12 | 12.5 | 12.5 |
| Retardant | AP462 | | | | | | | | | | | | |
| Silica | Cab-O-Sil | | | | | | | | | | | | |
| particles | TS720 | | | | | | | | | | | | |
| | A:E ratio | 1:0.61 | 1:0.42 | 1:0.13 | 1:0.32 | 1:0.34 | 1:0.24 | 1:0.26 | 1:0.50 | 1:0.50 | 1:0.50 | 1:0.75 | 1:0.5 |

| | | | | | | | | | | | | |
|---|---|---|---|---|---|---|---|---|---|---|---|---|
| Curing at 120 C. | 4 | 4 | 4 | 4 | 2 | 4 | 2 | 3^{Δ} | 4^{Δ} | 6 | 5 | 5 |
| Curing at 175 C. | 1 | 2 | 1 | 1 | 1 | 1 | 1 | 3^{Δ} | 2^{Δ} | 3 | 3 | 3 |

TABLE 3

| Type | Material | 25 | 26 | 27 | 28 | 29 | 30 | 31 | 32 | 33 | 34 | 35 | 36* |
|---|---|---|---|---|---|---|---|---|---|---|---|---|---|
| Epoxy | DLS 772 | 48 | 48.3 | 48.43 | 49 | 50 | 49.5 | 48.5 | 47.5 | 49.91 | 50.41 | 50.8 | |
| | Epikote 828 | | | | | | | | | | | | 44.57 |
| Hollow | Nanolite 37 c2 | 27 | 27 | 27.5 | 27.5 | 27.5 | 27.23 | 26.68 | 26.13 | 27.23 | 27.23 | 27.23 | 27 |
| Particles | | | | | | | | | | | | | |
| Curing | Dicyandiamide | | | | | | | | | | | | |
| Agent | MMIPA | | | | | | | | | | | | |
| | MDEA | | | 9.06 | | | | | | | | | |
| | MCDEA | 10.5 | 11.2 | 2.51 | 10 | 9 | 8.91 | 8.73 | 8.55 | 8.5 | 8 | 8 | 12.04 |
| | VDH | | | | | | | | | | | | 3.01 |
| | TSAH | | | | | | | | | | | | |
| | MZ Azine | | | | | | | | | | | | |
| Accelerator | Dyhard | 2 | 1 | | 1 | 1 | 0.99 | 0.97 | 0.95 | 0.99 | 0.99 | 0.6 | |
| | UR500 | | | | | | | | | | | | |
| Flame | Exolit | 12.5 | 12.5 | 12.5 | 12.5 | 12.5 | 12.38 | 12.13 | 11.88 | 12.38 | 12.38 | 12.38 | 12.8 |
| Retardant | AP462 | | | | | | | | | | | | |
| Silica | Cab-O-Sil | | | | | | 1 | 3 | 5 | 1 | 1 | 1 | 1 |
| particles | TS720 | | | | | | | | | | | | |
| | A:E ratio | 1:0.5 | 1:0.5 | 1:0.5 | 1:0.44 | 1:0.39 | 1:0.39 | 1:0.39 | 1:0.39 | 1:0.37 | 1:0.35 | 1:0.34 | 1:0.70 |

| | | | | | | | | | | | | |
|---|---|---|---|---|---|---|---|---|---|---|---|---|
| Curing at 120 C. | 3 | 3⁺ | 5 | 3⁺ | 3⁺ | 4 | 4 | 4 | 5 | 5 | 6 | 5 |
| | 1 | 1⁺ | 3 | 2⁺ | 2⁺ | 3 | 3 | 2 | 2^{Δ} | 3^{Δ} | 3^{Δ} | 3 |

TABLE 4

| Type | Material | 37* | 38 | 39 | 40* | 41* | 42* | 43* | 44 | 45* | 46* | 47* | 48* | 49* |
|---|---|---|---|---|---|---|---|---|---|---|---|---|---|---|
| Epoxy | DLS 772 | 45.62 | 50 | 53.54 | 46 | 46.5 | 45.5 | 46.5 | 58.25 | 49.92 | 49.62 | 47.97 | 46.42 | 47.22 |
| | Epikote 828 | | | | | | | | | | | | | |
| Hollow | Nanolite 37 c2 | 27 | 27 | 27 | 27 | 27 | 27 | 27 | 27 | 27 | 27 | 27 | 27 | 27 |
| Particles | | | | | | | | | | | | | | |
| Curing | Dicyandiamide | | | | | | | | | | | | | |
| Agent | MMIPA | | | | | | | 6.75 | | | | | | |
| | MDEA | | | 10.3 | | 6.75 | | | | | | | | |
| | MCDEA | | 8.5 | | | | 7.25 | | | | | | | |
| | VDH | 14 | | | | 6.75 | 7.25 | 6.75 | | 10.07 | 10 | 11.65 | 13.2 | 12.4 |
| | TSAH | | | | 14 | | | | | | | | | |
| | MZ Azine | | | | | | | | 1.748 | | | | | |
| Accelerator | Dyhard | | 1 | | | | | | | | | | | |
| | UR500 | | | | | | | | | | | | | |
| Flame | Exolit | 12 | 12 | 12 | 12.38 | 12 | 12 | 12 | 12 | 12 | 12.38 | 12.38 | 12.38 | 12.38 |
| Retardant | AP462 | | | | | | | | | | | | | |
| Silica | Cab-O-Sil | 1 | 1 | 1 | 1 | 1 | 1 | 1 | 1 | 1 | 1 | 1 | 1 | 1 |
| particles | TS720 | | | | | | | | | | | | | |
| | A:E ratio | 1:0.76 | 1:0.36 | 1:0.5 | 1:0.70 | 1:0.76 | 1:0.36 | 1:0.5 | 1:0.14 | 1:0.50 | 1:0.50 | 1:0.61 | 1:0.70 | 1:0.65 |

| | | | | | | | | | | | | | |
|---|---|---|---|---|---|---|---|---|---|---|---|---|---|
| Curing at 120 C. | 4 | 5 | 4 | 4 | 4 | 5 | 4 | 4^{Δ} | 4 | 4 | 4 | 4 | 4 |
| Curing at 175 C. | 3 | 3 | 2 | 3^{Δ} | 2^{Δ} | 2^{Δ} | 2^{Δ} | 4^{Δ} | — | 3 | 3 | 3 | 3 |

DLS772 - Diglycidyl ether of Bisphenol A (DGEBA). Supplied by Huntsman.
Epikote 828 - Diglycidyl ether of Bisphenol A (DGEBA). Supplied by Shell.
Exolit AP462 - Encapsulated ammonium polyphosphate. Supplied by Clariant GmbH
Nanolite 37 c2 - 45 micron amine coated microballoons. Supplied by Ecka
Dicy—Dicyandiamide. Supplied SKW Trostberg
Dyhard UR500 -3 N,N′-(4-Methyl-m-phenylene)bis(N′,N′-dimethylurea). Supplied by SKW Trostberg
MMIPA - 4,4′-Methylene bis(2-isopropyl-6-methylaniline). Supplied by Lonza Ltd.
MDEA - 4,4′-Methylene bis(2,6-diethylaniline). Supplied by Lonza Ltd.
MCDEA - 4,4′-Methylene bis(3-chloro-2,6-diethylaniline). Supplied by Lonza Ltd.
pTSAH - Para Toluene sulphonic acid. Supplied by Chance and Hunt.
2 MZ Azine-S - 6-[2-(Methylimidazole)ethyl]-1,3,5-triazine-2,4-diamine. Supplied by Anchor Chemical Ltd.
VDH—Valine dihydrazide. Supplied by Ajinomoto
Cab-O-Sil TS720 - surface modified fumed silica particles. Supplied by Cabot.

Examples 1 to 19 show how a known epoxy curing system, dicyandiamide and the urone accelerator UR500 was unable to produce a syntactic paste which cured at both 120° C. and 175° C. without exotherming regardless of the amount of material employed.

Examples 20 to 24 show how other, less reactive curatives than dicyandiamide were tested. However none of the combinations could provide satisfactory curing at both 120° C. to 175° C. The curing agent MCDEA showed some promise but was not reactive enough at 120° C. Examples 25 to 29 involved enhancing the MCDEA with the urone accelerator UR500. However none of these were satisfactory at both 120° C. and 175° C. either. Furthermore, some of the formulations phase-separated which would produce very poor mechanical properties in the cured foam. Addition of particulate silica in examples 30 to 35 solved the phase separation problem, however none of the formulations were able to cure satisfactorily at both 120° C. and 175° C.

Examples 36 to 39 were then tested. Although all four examples produced better results overall than earlier examples, the ones containing valine dihydrazide performed the best.

Example 37 which contained valine dihydrazide as the sole curing agent, was the best overall performer.

The rise in temperature of examples 37 to 39 as curing took place is shown in FIGS. 1 and 2. It can be seen that Example 37 increased in temperature by 45° in excess of the 120° C. environment temperature and never exceeded the 175° C. environment temperature.

Examples 40 to 45 were carried out to explore other curing agents similar to valine dihydrazide. All of these examples produced good curing results at both 120° C. and 175° C. The compressive tests carried out on the cured foams showed that Examples 41 to 44 were acceptable. However Example 44 was clearly the best of this series.

The rise in temperature of Examples 40 to 45 as curing took place is shown in FIGS. 3 and 4. It can be seen that Example 44 increased in temperature by 60° C. in excess of the 120° C. environment temperature and only increased by 10° C. in excess of the 175° C. environment.

Examples 46 and 49 explore the effect of the A:E ratio when valine dihydrazide is the sole curative. All cured well at both 120° C. and 175° C. with no exotherm problems.

The compressive strength (MPa) of the resulting foams was tested and the results are shown in Table 5.

TABLE 5

| Curing regime | 46 | 47 | 48 | 49 |
|---|---|---|---|---|
| 120° C. (for 1 hr) | 31 | 39 | 37 | 48 |
| 175° C. (for ½ hr) | 38 | 50 | 43 | 44 |

It can be seen that an A:E ratio of 1:0.65 in Example 49 provides optimal results.

1. A one-component syntactic paste comprising an epoxy resin, hollow particles and a hydrazide curing agent.

2. A syntactic paste according to claim a 1, wherein the hollow particles have a mean particle size of from 10 to 200 micrometres.

3. A syntactic paste according to claim 1, wherein the hollow particles have a density of from 0.20 to 0.5 0 g/cm³.

4. A syntactic paste according to claim 1, which comprises from 10 to 40 wt % of the hollow particles.

5. A syntactic paste according to claim 1, which has a density of less than 0.80 g/cm³.

6. A syntactic paste according to claim 1, comprising epoxy resin at a level of from 30 to 60 wt %.

7. A syntactic paste according to claim 1, wherein the hydrazide has a melting temperature of less than 175° C.

8. A syntactic paste according to claim 1, wherein the hydrazide comprises valine dihydrazide.

9. A syntactic paste according to claim 1, wherein the hydrazide is present at a level of from 5 to 20 wt %.

10. A syntactic paste according to claim 1, wherein the A: E ratio is from 1:0.4 to 1:0.9.

11. A syntactic paste according to claim 1, which has a mass of at least 100 g.

12. A syntactic paste according to claim 1, which exotherms by less than 70° C.

13. A syntactic paste according to claim 1, which cures over a temperature range of at least 20° C.

14. A syntactic paste according to claim 1, which does not exceed 195° C. at all curing temperatures from 120° C. to 175° C.

15. A process of curing a syntactic paste comprising heating a syntactic paste according to claim 1 by exposing said syntactic paste to an environment at a temperature of at least 80° C. to produce a cured syntactic foam.

16. A process according to claim 15, wherein the environment temperature is at least 100° C.

17. A process according to claim 15, which includes the step of applying the paste to an aircraft sandwich panel or to repair a damaged composite material before curing.

18. A cured syntactic foam obtainable by the process of claim 15, which has a compressive strength at room temperature of at least 16 Nmm⁻².

19. A cured syntactic foam comprising a syntactic paste according to claim 1 that has been cured.

20. A process for making a one-component syntactic paste comprising combining an epoxy resin with hollow particles and a hydrazide curing agent to form said one-component syntactic paste.
